(19) United States
(12) Patent Application Publication
(10) Pub. No.: US 2009/0098295 A1
(43) Pub. Date: Apr. 16, 2009

(54) PROCESS FOR PRODUCING A CORROSION-PROTECTED STEEL SHEET

(75) Inventors: Monika Riemer, Dortmund (DE); Ingo Rogner, Ingolstadt (DE); Bernd Schuhmacher, Dortmund (DE); Christian Schwerdt, Duisburg (DE)

Correspondence Address: PROSKAUER ROSE LLP;PATENT DEPARTMENT, 1585 BROADWAY, NEW YORK, NY, 10036-8299, US

(73) Assignee: THYSSENKRUPP STEEL AG, Duisburg (DE)

(21) Appl. No.: 11/577,981

(22) PCT Filed: Oct. 24, 2005
(86) PCT No.: PCT/EP05/11387

§ 371 Date: May 19, 2008

(30) Foreign Application Priority Data
Oct. 28, 2004 (DE) 10 2004 052 482.3

(51) Int. Cl. B05D 3/02

(52) U.S. Cl. 427/295

(57) ABSTRACT

A process for producing a corrosion-protected steel sheet for coating with an organic coating agent, includes vacuum-coating the steel sheet, which is protected against corrosion with a layer of zinc or zinc alloy, with at least one additional metal or a metal alloy. After vacuum-coating, the steel sheet is subjected to a thermal diffusion treatment and finally cooled down. The process is characterized according to the invention in that cooling takes place with a water-based coolant.

The invention relates to a process for producing a corrosion-protected steel sheet for coating with an organic coating agent, wherein the steel sheet protected against corrosion with a layer of zinc or zinc alloy coating is vacuum-coated with at least one additional metal or a metal alloy, then subjected to thermal diffusion treatment and finally cooled down.

In the automobile industry there is a huge demand for materials with high corrosion resistance and at the same time good working properties. The galvanizing of vehicle body steel sheet (hot-dip process or electrolytic coating) for the purpose of corrosion protection has generally become the standard over the past few decades. Steel sheet galvanized by the hot-dip process or by means of electrolytic deposition is marked by good adhesion of the zinc layer to the steel sheet and good workability, in particular formability.

However the problem regularly arises that an organic coating agent, in particular paint coating, has insufficient adhesion to the surface of the processed steel sheet. Oxygen and humidity penetrate through the paint film to the metal surface, which react with the latter and thus lead to progressive degradation of the surface. In order to prevent this and thus to ensure sufficient paint adhesion, the steel sheet is subjected to an additional intermediate treatment (chromatising for example), which means additional cost and is to some extent ecologically unsound due to the use of Cr^{VI} containing substances.

Processes of the kind detailed at the beginning are known from the state of the art. DE 100 39 375 A1 describes a process for producing a corrosion-protected steel sheet, wherein a layer of metal, in particular alkaline earth metal, magnesium or aluminium or their alloys, are applied onto a steel sheet provided with a layer of zinc or zinc alloy in a continuous process by vacuum coating. Subsequently the coated sheet metal is subjected to thermal treatment. During this thermal treatment, which consists of a heating up and a heat-retention phase, fusion penetrations occur locally in sections of the surface, where during vacuum coating multiphase alloys have formed between the vapour-deposited layer and the layer of zinc or zinc alloy with a melting temperature, which is lower relative to the layer of zinc or zinc alloy. In this case the vapour-deposited metal or the vapour-deposited alloy also penetrates into deeper layers of the zinc coating. Following thermal treatment the steel sheet is cooled down in an invariably low oxygen atmosphere, whereby the fusion penetrations become solid.

The corrosion resistance of the galvanized steel sheet is positively affected by this process as a result of the decomposition of the zinc coating being vastly slowed down through the stabilizing effect of the vapour-deposited metal, which has entered the zinc coating due to the fusion penetrations.

DE 195 27 515 C1 describes a further process for producing a corrosion-protected steel sheet. In this case one or several metals, apart from zinc, in particular Fe, Mn, Cu, Ni and Mg, or their alloys, is applied onto a steel sheet provided with a zinc-containing layer by vacuum coating and then without being exposed in the meantime to oxidizing atmosphere, is subjected to thermal diffusion treatment with subsequent cooling in an inert gas atmosphere. In the course of the diffusion treatment a layer of a zinc-rich alloy and also of phases mixed with the metal or metals applied by vacuum forms on the surface. By means of this process production of a galvanized steel sheet with good surface quality and corrosion resistance is possible.

In the case of the process known from the prior art however, the apparent cost is high, since not only the thermal treatment, but also the cooling process subsequent thereto, have to be carried out in an inert gas atmosphere.

The object of the invention is therefore to indicate a process for producing a corrosion-protected steel sheet for coating with an organic coating agent, which in comparison to the generic-equivalent state of the art, is marked by excellent adhesion of the organic coating agent as well as by high corrosion resistance, also in the coated state of the sheet metal.

The object is achieved according to the invention with a process according to the preamble of patent claim 1, wherein cooling takes place with a water-based coolant under normal atmospheric conditions.

In the case of the process according to the invention, firstly in the known way a steel sheet is provided with a layer of zinc or zinc alloy. This takes place in the way known per se by the hot dip process (hot-galvanizing) or through electrolytic deposition. Then the galvanized steel sheet is vacuum-coated with an additional metal. This is followed by thermal diffusion treatment, wherein atoms of the metal layer applied by vacuum diffuse into the layer of zinc or zinc alloy lying below. As a result of the residual gas remaining in the vacuum and during the thermal diffusion treatment, a native oxide film is formed on the surface of the coated steel sheet, which passivates the surface and therefore increases its corrosion resistance. According to the invention, it is proposed that the processed steel sheet is cooled down after the thermal diffusion treatment with a water-based coolant.

As a result of using a simple water-based coolant the production investment and therefore the costs occurring in comparison to the process known from the prior art are substantially reduced. In this case as studies by the applicant have surprisingly shown, at least equivalent results regarding corrosion resistance and paint adhesion are obtained. As expected with treatment using water, oxidation problems would arise. Surprisingly negative reactions with the additional metal have not occurred. As further experiments by the applicant have shown, intermediate treatment, considered by the industry as necessary prior to applying an organic coating agent, can be entirely dispensed with. This however is also possible in the case of build up mixed with conventional products.

Because cooling takes place through the water-based coolant under normal atmospheric conditions, no encapsulating of the workstation where cooling takes place, or filling of the same with process gas is necessary.

A further advantage of cooling using a water-based coolant is due to the fact that in some sections of the coated surface, in which no native oxide film forms, that is to say on which the bare metallic coating lies exposed, water molecules from the coolant are decomposed, forming corrosion-protecting hydroxides which are sometimes not very soluble. These hydroxides or the oxides arising therefrom during subsequent drying substantially improve the adhesion of organic coating agents on the surface of the steel sheet.

The layer applied by vacuum on the galvanized sheet metal can be built up from one or several metals. Preferably such metals, which form mixed phases with the zinc of the layer of zinc or zinc alloy, are used. As a result both layers adhere well together and corrosion resistance is increased. Reactive metals such as magnesium, aluminium, iron or their alloys are shown to be particularly advantageous.

As the result of a preset temperature progression in the sense of a defined start temperature of the processed steel sheet at the beginning of cooling, preset temperature of the coolant as well as a specific cooling period, both the treatment time can be reduced and the quality of the corrosion protection layer can be improved in the sense of higher corrosion resistance.

The start temperature of the steel sheet at the beginning of cooling is preferably 250 to 350° C., in particular 290 to 310° C. The start temperature can be obtained technically in different ways. Thus the use of cooling rollers is possible, just as the use of gas cooling. The cooling period in this case is preferably 1 to 10 seconds. The temperature of the coolant should not be selected too highly, since in this case the metal coating of the steel sheet would be heavily attacked by the coolant. Preferably the temperature of the coolant should not exceed 42° C.

The final temperature of the steel sheet after cooling is preferably 20 to 120° C., in particular 40 to 60° C. As a result a further production stage results. Increasing the final temperature above 120° C. is not sensible, since otherwise damage to the following rubberized rollers for removing the coolant may occur.

In order to avoid visible patterns forming on the surface, it is expedient to completely wet the coated steel sheet directly at the beginning of cooling with the water-based coolant. For this purpose cooling can be carried out in a dip tank. Likewise the coated steel sheet can also be sprayed, spraying being preferably carried out at high pressure, since in this case particularly rapid cooling and passivation of the surface can be achieved. Also in the case of very hot metal surfaces the vaporized layer, which forms directly on the surface and which greatly reduces the transition of heat between the steel sheet and coolant, in this way can be broken up (Leidenfrost effect).

Sensibly the water-based coolant should be removed immediately after the surface of the coated steel sheet has cooled down. As a result the native oxide film lying over the surface of the processed steel sheet is stabilized. The coolant can be removed for example by squeezing rollers or also by a gas jet.

The corrosion resistance and adhesion of the organic coating being applied can be further improved by other measures. Thus soluble salts can be added to the water-based coolant. These release advantageous bivalent metal ions or hydroxide ions and therefore move the solution equilibrium towards the undissociated oxide as per the equation:

M-oxide+H₂O [symbol] M OH)₂ [symbol] M²⁺+2 OH

M: metal atom

As a result decomposition of the protecting native oxide film can be reduced and this can be stabilized.

Likewise buffering substances, in particular acetate, phosphate, borate, carbonate, or citrate ions, can be added to the water-based coolant, through which an optimum pH value can be obtained in the sense of minimum hydrolysis of amphoteric native metallic oxides. Thus the pH value should not lie either in the low acidic range (pH<5) or in the high basic range (pH>12.5).

As a result of using carbonate ions as buffer-substance additional stabilisation of the sheet metal surface can be achieved through the formation of insoluble carbonates.

Due to the particularly simple execution, according to the invention, of the cooling step in the production of corrosion-protected steel sheet, it is finally possible without difficulty to coat, diffusion-treat and cool the steel sheet as strip in a continuous process. Thus the method according to the invention is also suitable for large-scale operation in strip coating installations.

Since intermediate treatment of the coated, diffusion-created and subsequently cooled steel sheet is no longer necessary before an organic coating agent is applied due to the outstanding paint adhesion properties of the surface, it is possible to apply the organic coating agent immediately after the water-based coolant is removed. Thus the production process can be substantially accelerated, which leads to further cost savings.

The invention is described below in detail on the basis of a drawing illustrating an exemplary embodiment. The drawing shows an installation for continuous processing and subsequent paint finishing of steel strip.

In accordance with the drawing a substrate in the form of a steel strip 1 is first fed through one or more cells 2 and coated by an electrolytic deposition process with a zinc layer. Zinc deposition is also possible using a hot dip process (hot-dip galvanizing). Subsequently thereto the steel strip 1 enters a vacuum chamber 3. Here the strip 1 is coated by a coating process known from the state of the art, by means of PVD for example, with an additional metal, preferably magnesium. Further suitable metals are aluminium and manganese for example.

As a result of the residual gas in the vacuum chamber 3 a native oxide film immediately develops on the magnesium coat. This native oxide film can be controlled by adjusting the partial pressure of 0₂ or H₂0 in the residual gas atmosphere of the vacuum chamber 3.

After leaving the vacuum chamber 3 the coated galvanized steel strip 1 enters a heating chamber 4 equipped with a heating device 4a. Then thermal diffusion treatment takes place in this heating chamber 4, which can be carried out at normal atmosphere. In the course of diffusion treatment the magnesium layer applied by vacuum partly diffuses into the zinc layer lying below, forming inter-metallic phases consisting of zinc and magnesium.

After withdrawal from the heating chamber 4 the steel strip 1 is guided around at least one cooling cell 5 and cooled there to a defined temperature. This is at the same time the start temperature of the now subsequent cooling stage and is preferably 250 to 350° C., in particular 290 to 310° C.

For controlled cooling the steel strip 1 is fed into a further chamber 6. In this chamber, where normal atmospheric conditions also prevail, the diffusion-treated surface is sprayed with a water-based coolant at high pressure. As an alternative to spray application, cooling can also take place in a dip tank. The water-based coolant can be pure water. However salts may also be dissolved in the coolant, which move the solution equilibrium towards the undissociated oxide. Equally the coolant may contain buffering substances, for example acetate, phosphate, borate, carbonate, or citrate ions, through which an optimum pH value can be obtained in the sense of minimum hydrolysis of amphoteric native metallic oxides.

Preferably the spray device is to be designed in such a manner that the coated steel sheet is completely wetted directly at the beginning of cooling with the water-based coolant, in order to avoid visible patterns forming on the surface. Cooling in the chamber 6 takes place with a preset temperature progression. In this case the temperature of the coolant is 42° C. maximum. The working period of the coolant on the steel strip 1 is between 1 and 10 seconds.

Immediately after withdrawal from the chamber 6 the coolant is removed from the strip surface by squeezing rollers 7. In this case the residual heat of the strip 1 assists in removing the coolant by evaporation. Alternatively the coolant can also be removed by a gas jet.

Then the dry steel strip 1 can be fed without intermediate treatment to a coating machine 8, which coats the steel strip 1 on line in a continuous roller coating operation. Alternatively the paint finish can also be applied off line by means of roller coating, spraying or dipping.

1. A process for producing corrosion-protected steel sheet for coating with an organic coating agent, wherein the steel sheet protected against corrosion with a layer of zinc or zinc alloy, is vacuum-coated with at least one additional metal or a metal alloy, then subjected to thermal diffusion treatment and finally cooled down, wherein cooling takes place with a water-based coolant under normal atmospheric conditions.

2. The process according to claim 1, wherein at least one additional metal with zinc forms a mixed phase.

3. The process according to claim 1, wherein at least one additional metal is a metal selected from the group consisting of Mg, Al, Mn or alloys thereof.

4. The process according to claim 1, wherein cooling takes place with a preset temperature progression.

5. The process according to claim 1, wherein a start temperature of the steel sheet at the beginning of cooling is 250 to 350° C.

6. The process according to claim 1, wherein a start temperature of cooling is obtained by means of cooling rollers.

7. The process according to claim 1, wherein a start temperature of cooling is obtained by means of gas cooling.

8. The process according to claim 1, wherein the cooling period is 1 to 10 seconds.

9. The process according to claim 1, wherein the temperature of the water-based coolant is a maximum of 42° C.

10. The process according to claim 1, wherein a final temperature at the end of cooling is 20 to 120° C.

11. The process according to claim 1, wherein the coated steel sheet is completely wetted directly at the beginning of cooling with the water-based coolant.

12. The process according to claim 1, wherein cooling takes place in a dip tank.

13. The process according to claim 1, wherein cooling takes place by spraying.

14. The process according to claim 13, wherein the water-based coolant is spray-applied at high pressure.

15. The process according to claim 1, wherein the water-based coolant is removed immediately after the surface of the coated steel sheet has cooled down.

16. The process according to claim 15, wherein the water-based coolant is removed by squeezing rollers.

17. The process according to claim 15, wherein the water-based coolant is removed by gas jet.

18. The process according to claim 1, wherein the water-based coolant contains soluble salts, that release bivalent metal ions or hydroxide ions, which move the solution equilibrium towards the undissociated oxide.

19. The process according to claim 1, wherein the water-based coolant contains buffering substances.

20. The process according to claim 19, wherein the water-based coolant contains as buffering substances acetate, phosphate, borate, carbonate, or citrate ions.

21. The process according to claim 1, wherein the steel sheet is coated, diffusion-treated and cooled as strip on line in a continuous production process.

22. The process according to claim 1, wherein the organic coating agent is applied after the water-based coolant is removed without intermediate treatment.
